(19) United States
(12) Patent Application Publication
(10) Pub. No.: US 2024/0068877 A1
(43) Pub. Date: Feb. 29, 2024

(54) INSTALLATION STRUCTURE OF SENSOR

(71) Applicant: Yazaki Corporation, Tokyo (JP)

(72) Inventors: Hiraku TANAKA, Shizuoka (JP); Tomohiro MATSUSHIMA, Shizuoka (JP); Kenta TANAKA, Shizuoka (JP); Yusuke YAMADA, Shizuoka (JP)

(73) Assignee: Yazaki Corporation, Tokyo (JP)

(21) Appl. No.: 18/237,142

(22) Filed: Aug. 23, 2023

(30) Foreign Application Priority Data
Aug. 29, 2022 (JP) 2022-135657

(51) Int. Cl. G01K 1/14; G01K 13/024

(52) U.S. Cl. CPC G01K 1/14; G01K 13/024

(57) ABSTRACT

The installation structure of a sensor includes a sensor body, a holder provided with a locking part and configured to install the sensor body by locking the sensor body with the locking part, the locking part configured to deform when installing the sensor body to the holder and configured to restore when installation of the sensor body to the holder is completed, and a holder-installation body provided with an installable portion where the holder is to be installed and configured to prevent a deformation of the locking part of the holder.

### CROSS REFERENCE TO RELATED APPLICATION

The present application is based on, and claims priority from Japanese Patent Application No. 2022-135657, filed on Aug. 29, 2022, the entire contents of which are incorporated herein by reference.

### TECHNICAL FIELD

The disclosure relates to an installation structure of a sensor.

### RELATED ARTS

JP2019-2876A describes an intake air temperature sensor for battery cooling that uses solder to connect an element to a wire, and in addition, components such as a holder and a housing (sensor body) are integrated.

### SUMMARY

By the way, when a fault occurs in the sensor, the intake air temperature sensor for battery cooling has to be replaced from the sensor to the wire, which impairs interchangeability of the sensor.

Therefore, it is conceivable to improve the interchangeability of the sensor in the event of a fault by using a connector to connect the temperature sensing element to the wire and by separating the holder and the housing (the sensor body) from each other. Moreover, if the holder and the housing (the sensor body) are separated from each other, the holder can be assembled to various mating partners by changing a shape of the holder. However, the problem is that the holding force between the holder and the housing (the sensor body) becomes weak when the wire is pulled.

To solve this problem, if a strong fitting is provided between the connectors included in the holder and the housing, the intake air temperature sensor becomes large in size. These problems occur in other sensors as well as in the intake air temperature sensor for battery cooling.

The present disclosure is intended to provide an installation structure of a sensor that can increase a joining strength between the sensor body and the holder without increasing the size.

An installation structure of sensor according to one ore more embodiments include a sensor body, a holder provided with a locking part and configured to install the sensor body by locking the sensor body with the locking part, the locking pan configured to deform when installing the sensor body to the holder and configured to restore when installation of the sensor body to the holder is completed, and a holder-installation body provided with an installable portion when the holder is to be installed and configured to prevent a deformation of the locking part of the holder.

### BRIEF DESCRIPTION OF THE DRAWINGS

FIG. 1 is a perspective view of a sensor in an installation structure of the sensor according to one or more embodiments;

FIG. 2 is an arrow II view in FIG. 1;

FIG. 3 is an arrow III view in FIG. 1;

FIG. 4 is a view illustrating a cross-section IV-IV in FIG. 2;

FIG. 5 is a view illustrating a sensor body in the installation structure of the sensor according to the one or more embodiments;

FIG. 6 is an arrow VI view in FIG. 5;

FIG. 7 is a perspective view of a holder in the installation structure of the sensor according to the one or more embodiments;

FIG. 8 is an arrow VIII view in FIG. 7;

FIG. 9 is a view of the installation structure of the sensor according to the one or more embodiments before the sensor body is installed in the holder;

FIG. 10 is a perspective view of the installation structure of the sensor according to the one or more embodiments before the sensor body is installed in the holder;

FIG. 11 is a view illustrating a cross-section XI-XI in FIG. 8; and

FIG. 12 is a view illustrating a cross-section XII-XII in FIG. 8.

### DETAILED DESCRIPTION

Various embodiments will be described hereinafter with reference to the accompanying drawings.

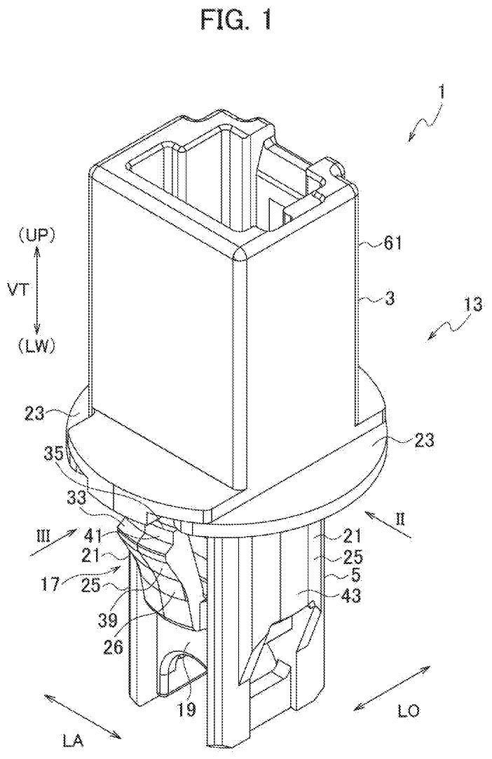

As illustrated in FIGS. 1 to 4, an installation structure 1 of a sensor according to one or more embodiments comprise a sensor body 3, a holder 5, and a holder-installation body (for example, a duct) 7. The sensor body 3 is configured to detect, for example, temperature. In FIG. 1, display of the holder-installation body 7 is omitted.

Here, for convenience of explanation, one predetermined direction in the installation structure 1 of the sensor is taken as a longitudinal direction LO. Another predetermined direction perpendicular to the longitudinal direction LO is taken as a lateral direction LA. A direction perpendicular to the longitudinal direction LO and the lateral direction LA is taken as a vertical direction VT.

The holder 5 is provided with a locking part 9. When the sensor body 3 is installed in the holder 5, the locking part 9 is elastically deformed by being pushed by the sensor body 3 during installation. The locking part 9 is restored when the sensor body 3 is installed in the holder 5. Since the sensor body 3 is locked in the locking part 9, the sensor body 3 is installed in the holder 5.

To explain further, the sensor body 3 is provided with a lockable part 11. When the installation of the sensor body 3 to the holder 5 is completed, the lockable part 11 of the sensor body 3 is locked to the locking part 9 of the holder 5, so that the sensor body 3 is integrally installed in the holder 5. The sensor body 3 is installed in the holder 5, so that the sensor 13 is formed.

The holder-installation body 7 is provided with an installable portion 15 where the holder 5 is installed. The holder 5 where the sensor body 3 is installed is integrally installed in the installable portion 15, so that the deformation of the locking part 9 of the holder 5 is prevented. The deformation prevented above is the same deformation as when the sensor body 3 is installed.

To explain further, the holder 5 is provided with an installation portion 17. When installation of the holder 5 where the sensor body 3 is installed on the holder-installation body 7 is completed, the installation portion 17 of the holder 5 is locked to the installable portion 15 of the holder-installation body 7. Then, the holder 5 where the sensor body 3 is installed is integrally installed on the holder-installation body 7.

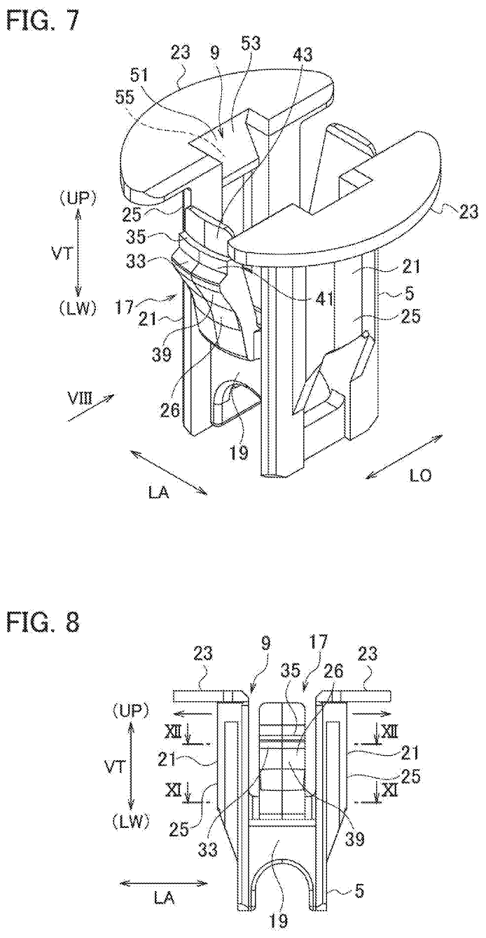

As illustrated in FIG. 7, FIG. 8, etc., the holder 5 is formed in a U-shape with a bottom section 19 and a pair of side sections 21 which stand up from opposite edges in the lateral direction LA of the bottom section 19 to a upper side UP by a predetermined length (height). In other words, a U-shaped part is formed with the bottom section 19 and the pair of side sections 21. At least a part of the locking part 9 of the holder 5 is composed of a pair of side sections 21.

The holder 5 is configured to deform such that the pair of side sections 21 that composes the locking part 9 open (an upper part of the U-shaped pan to open) by being pushed by the sensor body 3 when the sensor body 3 is installed in the holder 5.

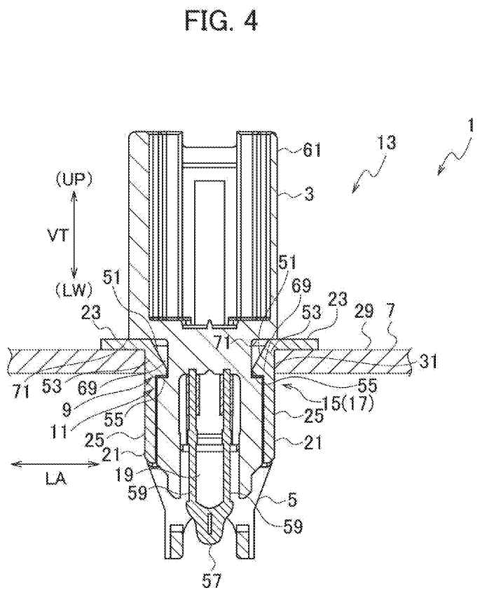

In addition, since the holder 5 is installed in the holder-installation body 7, the pair of side sections 21 are sandwiched laterally by the holder-installation body 7 and abut on the holder-installation body 7 as illustrated in FIG. 4, etc. Deformation such as the opening of the pair of side sections 21 of the holder 5 that composes the locking pan 9 (opening of the upper pan of the U-shaped part) is prevented.

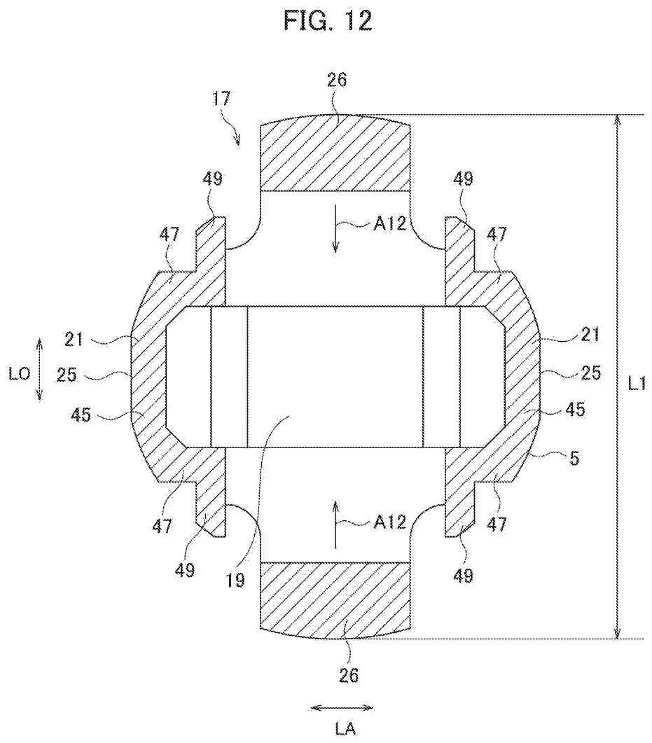

When viewed in a standing direction (the vertical direction VT) of the pair of side sections 21, side body parts 25 of the pair of side sections 21 are curved along an arc of a circle centered on a center of the holder 5 as illustrated in FIG. 12, etc. Each side body part 25 is a part of one side section 21 of the pair of side sections 21 that extends long in the vertical direction VT, except for a flange 23, etc., formed at an upper end of the one side section 21. When viewed in the standing direction (the vertical direction VT) of the pair of side parts 21, the pair of side body parts 25 are symmetrical with respect to a plane passing through the center of the holder 5 and perpendicular to the lateral direction LA.

As described above, the sensor body 3 is provided with a lockable part 11. The lockable part 11 of the sensor body 3 is configured to be locked to the locking part 9 of the holder 5 when the installation of the sensor body 3 to the holder 5 is completed. The sensor body 3 is configured to be integrally installed to the holder 5.

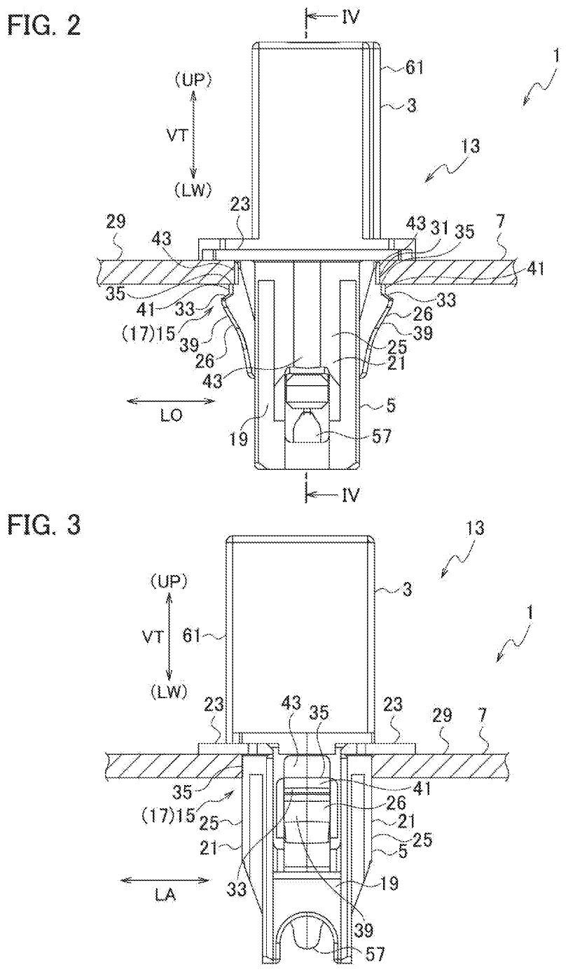

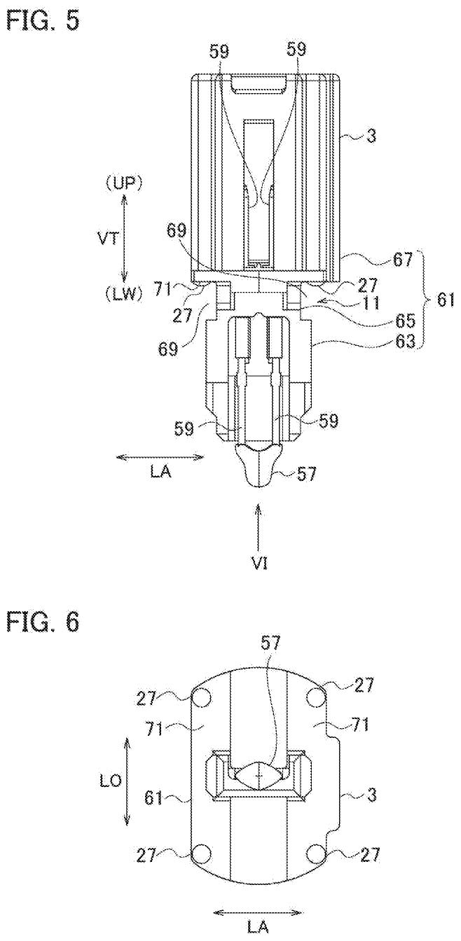

In the installation structure 1 of the sensor, at least a part of the lockable part 11 of the sensor body 3 (for example, protrusions 27; see FIG. 5) abut on the holder 5 with a biasing force when the installation of the sensor body 3 to the holder 5 is completed (a first mode). In FIGS. 2, 3, and 4, the protrusion 27 is omitted.

In the installation structure 1 of the sensor, at least a part of the locking part 9 of the holder 5 (for example, a protrusion not illustrated) may abut on the sensor body 3 with a biasing force when the installation of the sensor body 3 to the holder 5 is completed (a second mode).

In addition, the installation structure 1 of the sensor may be configured to take at least one of the first mode and the second mode described above. The first mode and the second mode are for preventing the occurrence of slight rattling between the sensor body 3 and the holder 5 after the sensor body 3 has been installed in the holder 5.

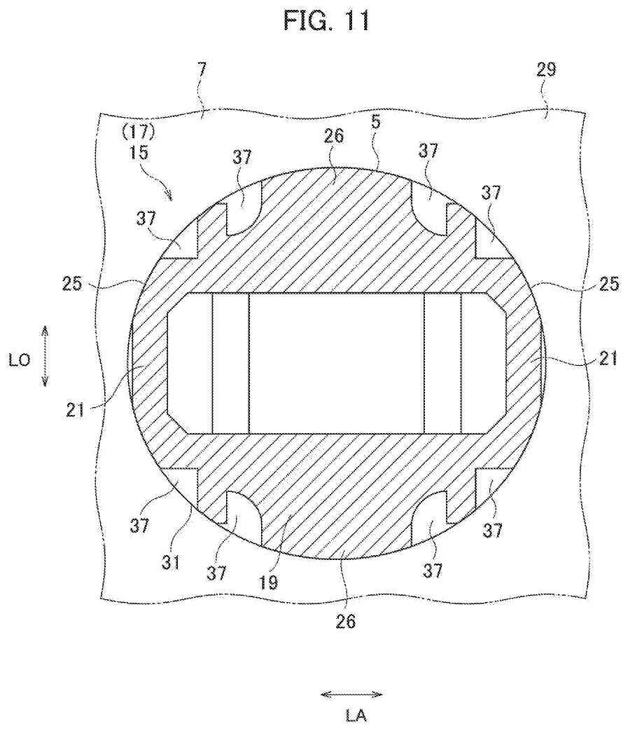

The installable portion 15 of the holder-installation body 7 is composed of a flat plate-shaped part 29 and a through-hole 31 (see FIG. 11) of a predetermined shape penetrating the flat plate-shaped part 29 in a thickness direction (the vertical direction VT). The through-hole 31 is formed in an elliptical shape when viewed in the vertical direction VT, for example. The through-hole 31 may be formed in a shape other than the elliptical shape when viewed in the vertical direction VT. For example, the through-hole 31 may be formed in a circular shape or a polygonal shape such as a rectangular shape when viewed in the vertical direction VT. In such cases, a shape of a part of the holder 5 that enters the though-hole 31 is also appropriately changed to match the shape of the through-hole 31.

The holder 5 is provided with the installation portion 17 as described above and as illustrated in FIG. 7, FIG. 8, etc. The installation portion 17 includes the flange 23, which is provided at the upper end of each side section 21 of a pair of side sections 21, and a pair of elastic arms 26. Separate from the pair of side sections 21, the pair of elastic arms 26 stand upward for a predetermined length from opposite edges in the longitudinal direction LO of the bottom section 19. The standing height of the elastic arms 26 is lower than the standing height of the side sections 21. As illustrated in FIG. 7, a plurality of contact surfaces 33, 35 (for example, two contact surfaces) are provided at a tip (an upper end) of each elastic arm 26 of the pair of elastic arms 26. The contact surfaces 33, 35 are slightly separated from each other in the vertical direction VT.

When the holder 5 is installed in the installable portion 15 while the holder 5 is inserted into the through-hole 31 provided in the flat plate-shaped part 29 of the installable portion 15, each elastic arm 26 elastically deforms by being pushed by edges of the through-hole 31 (see arrow A12 in FIG. 12). In addition, the pair of elastic arms 26 restore when the holder 5 is installed in the installable portion 15.

The flange 23 is configured to abut on one surface tan upper surface) in the thickness direction of the flat plate-shaped part 29 of the installable portion 15. In addition, a predetermined pair of contact surfaces (for example, a pair of the contact surfaces 35) among the plurality of contact surfaces 33, 35 of the pair of elastic arms 26 is configured to abut on the other surface (a lower surface) in the thickness direction of the flat plate-shaped part 29 of the installable portion 15.

Thus, the flat plate-shaped part 29 of the installable portion 15 is sandwiched between a pair of the flanges 23 and the predetermined pair of contact surfaces 35 in the vertical direction VT. The holder 5 is configured to be integrally installed on the holder-installation body 7.

In the installation structure 1 of the sensor, a par of the sensor body 3 (for example, the lockable pan 11) that engages at least with the holder 5 is formed symmetrically with respect to a plane perpendicular to the lateral direction LA and including a center of the sensor body 3.

In addition, a part of the holder 5 (for example, the locking part 9) that engages at least with the sensor body 3 is formed symmetrically with respect to a plane perpendicular to the lateral direction LA and including the center of the holder 5. Furthermore, a part of the holder 5 that engages at least with the holder-installation body 7 (for example, the installation portion 17) is formed symmetrically with respect to the plane perpendicular to the lateral direction LA and including the center of the holder 5. The whole of the holder 5 is formed symmetrically with respect to the plane perpendicular to the lateral direction LA and including the center of the holder 5. The whole of the holder 5 is formed symmetrically with respect to a plane perpendicular to the longitudinal direction LO and including the center of the holder 5. The through-hole 31 of the holder-installation body 7 is formed symmetrically with respect to a plane perpendicular to the lateral direction LA (or/and the longitudinal direction LO) and including a center of the through-hole 31.

Here, the installation structure 1 of the sensor is described in more detail. The sensor body 3 is configured to detect air temperature (for example, a temperature of an intake air for cooling a high-voltage battery). In the present embodiment, the holder-installation body 7 is a duct through which air flows. Below the flat plate-shaped part 29 of the duct 7 illustrated in FIG. 4 is an inner space of the duct 7, through which the intake air for cooling the high-voltage battery flows. Above the flat plate-shaped part 29 of the duct 7 illustrated in FIG. 4 is an outer space of the duct 7.

The flat plate-shaped part 29 of the holder-installation body 7 is arranged so that a thickness direction of the flat plate-shaped part 29 is the vertical direction VT, and a long axis of the through-hole 31 with the elliptical shape extends in the lateral direction LA and a short axis extends in the longitudinal direction LO, as illustrated in FIG. 11. The elliptical shape of the through-hole 31 prevents the holder 5 from rotating with respect to the duct 7 when the holder 5 with the sensor body 3 installed is installed in the duct 7. As described above, the through-hole 31 may be formed in a shape other than the elliptical shape such as a circular shape.

As already understood and as illustrated in FIG. 7, FIG. 8, etc., the holder 5 includes the bottom section 19, the pair of side sections 21, and the pair of elastic arms 26. The holder 5 is made of synthetic resin.

When viewed in the vertical direction VT, as illustrated in FIG. 11, the bottom section 19, an entire length of the side body part 25 of the pair of side sections 21, and a lower end of the pair of elastic arms 26 are shaped to fit within the through-hole 31 of the holder-installation body 7. Furthermore, when viewed in the vertical direction VT, various recesses 37 are formed on an outer periphery over the entire length of the side body part 25 of the pair of side sections 21 and an outer periphery of the lower end of the pair of elastic arms 26. However, if the recesses 37 are not formed, the outer periphery over the entire length of the side body part 25 of the pair of side sections 21 and the outer periphery of the lower end of the pair of elastic arms 26 are formed in an elliptical shape which is a shape substantially same as the shape of the through-hole 31. As described above, the outer periphery may be formed in a shape other than an elliptical shape such as a circular shape.

An inclined surface 39 is provided on the upper side from the lower end of each pair of elastic arms 26. By providing the inclined surface 39, the longitudinal dimension L1 (see FIG. 12) on the pair of elastic arms 26 becomes progressively larger toward the upper side.

When the holder 5 is installed on the holder-installation body 7, the inclined surface 39 abuts on the edge of the through-hole 31, causing the pair of elastic arms 26 to elastically deform and flex (see arrow A12 in FIG. 12), and the dimension L1 becomes smaller.

In addition, the upper end of each elastic arm 26 is provided with contact surfaces 41 and 43 in addition to the contact surfaces 33 and 35. The contact surface 41 is provided between the contact surface 33 and the contact surface 35 in the vertical direction VT. The contact surface 43 is provided on the upper side of the contact surface 35.

In a mode the holder 5 is installed on the holder-installation body 7 and the contact surface 35 abuts on the lower surface of the flat plate-shaped part 29, the contact surface 43 abuts on the edge of the though-hole 31. Further, in a mode the holder 5 is installed on the holder-installation body 7 and the contact surface 33 abuts on the lower surface of the flat plate-shaped part 29, the contact surface 41 abuts on the edge of the through-hole 31.

When the side sections 21 are viewed in the vertical direction VT, as illustrated in FIG. 12, one side section 21 of the pair of side sections 21 is composed of a longitudinally long first part 45, a pair of second parts 47, and a pair of third parts 49. The one side section 21 of the pair of side sections 21 is located on a left side in the lateral direction in a paper of FIG. 12.

One second part 47 of the pair of second parts 47 (the second part located on upper side in the paper of FIG. 12) projects laterally toward the center side of the holder 5 from one longitudinal end of the first pan 45 (one end of the first part located on upper side in the paper of FIG. 12). The other second part 47 of the pair of second parts 47 (the second part located on lower side in the paper of FIG. 12) projects laterally toward the center side of the holder 5 from the other longitudinal end of the first part 45 (the other end of the first part located on lower side in the paper of FIG. 12).

One third part 49 of the pair of third parts 49 (the third part located on upper side in the paper of FIG. 12) projects longitudinally toward a side away from the center of the holder 5 from the lateral end of the one second part 47.

The other third part 49 of the pair of third parts 49 (the part located on lower side in the paper of FIG. 12) projects longitudinally toward a side away from the center of the holder 5 from the lateral end of the other second part 47. The other side section 21 of the pair of side sections 21 (the side section 21 on a right side in the paper of FIG. 12) is formed symmetrically with the one side section 21 of the pair of side the side sections 21 (the side section 21 on the left side in FIG. 12). With this configuration, the side sections 21 are, substantially, curved along the arc of the circle at the center of the holder 5 when viewed in the vertical direction VT.

Each of the pair of side sections 21 comprises a protruding part 53 with an inclined surface 51 as illustrated in FIG. 7, etc. The protruding part 53 is located between the pair of second parts 47 of the side body part 25 in the longitudinal direction LO. The protruding part 53 projects from the first part 45 of the side body part 25 to the center side of the holder 5 in the lateral direction LA. The protruding part 53 is located at the upper end of the side section 21 in the vertical direction VT. A lower surface 55 of the protruding part 53 is a plane perpendicular to the vertical direction VT.

When installing the sensor body 3 in the holder 5, each side section 21 elastically deforms by the contact of the sensor body 3 with the inclined surface 51 of the protruding part 53. When the sensor body 3 is installed in the holder 5, each side section 21 is restored and the lower surface 55 of the protruding part 53 abuts on the sensor body 3.

As illustrated in FIG. 5, the sensor body 3 comprises an element (temperature sensing element) 57, a lead wire 59, and a housing 61. The lead wire 59 extends upward from the temperature sensing element 57. The housing 61 is made of synthetic resin. The housing 61 is integrally installed on the lead wire 59 so as to cover a part of the lead wire 59 (a middle part of the lead wire 59 in the vertical direction VT).

The housing 61 comprises a lower part 63, an intermediate part 65, and an upper part 67. The lateral dimension of the lower part 63 is larger than the lateral dimension of the intermediate part 65. The lateral dimension of the upper part 67 is also greater than the lateral dimension of the intermediate part 65. Thus, a pair of rectangular recesses 69 are formed by the intermediate part 65.

When the sensor body 3 is installed in the holder 5, each of the pair of protruding parts 53 of the holder 5 enters each of the pair of rectangular recesses 69, so that the sensor body 3 is installed integrally in the holder 5.

The upper part 67 of the housing 61 is formed in a cylindrical shape, and an upper end of the lead wire 59 is expressed in the upper part 67. Thus, the upper part 67 of the sensor body 3 is a male terminal whose upper end is open. A female terminal, not illustrated, is detachably attached to the male terminal.

In FIGS. 2 to 4, etc., a lower surface 71 of the upper pan 67 of the housing 61 is flat, while the lower surface 71 of the upper part 67 of the housing 61 is provided with the protrusions 27 as illustrated in FIGS. 5 and 6. If the protrusions 27 are not provided, the lower surface 71 of the upper part 67 abuts directly to the holder 5 when the sensor body 3 is installed in the holder 5.

The assembly operation in the installation structure 1 of the sensor is described next.

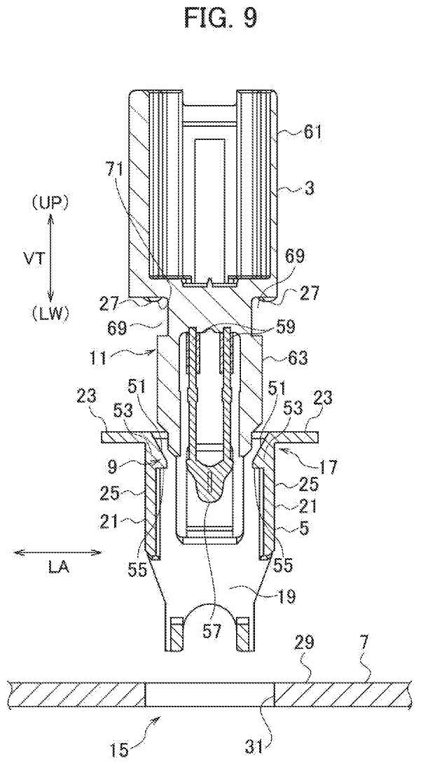

In the initial state, as illustrated in FIG. 9, the sensor body 3 is separated from the holder 5 and the holder 5 is separated from the holder-installation body 7.

When the sensor body 3 is moved downward with respect to the holder 5 from the state illustrated in FIG. 9, the lower part 63 of the housing 61 of the sensor body 3 abuts on the inclined surface 51 of the holder 5 and the pair of side sections 21 elastically deform. When the sensor body 3 is moved further downward with respect to the holder 5, the side sections 21 are restored and the protruding part 53 of each side section 21 of the holder 5 enters the rectangular recesses 69 of the housing 61 of the sensor body 3. In this state, the sensor body 3 is installed in the holder 5.

Then, the holder 5 on which the sensor body 3 is installed is moved from the upper side of the holder-installation body 7 to the lower side LW with respect to the holder-installation body 7 by inserting the holder 5 into the through-hole 31. As a result, the inclined surface 39 of the elastic arm 26 of the holder 5 abuts against the edge of the through-hole 31, and the elastic arm 26 is elastically deformed (see arrow A12 in FIG. 12).

When the holder 5 is moved further downward with respect to the holder-installation body 7, the elastic arms 26 are restored, and the flange 23, the contact surfaces 35 and the contact surface 43 of the elastic arms 26 abuts the holder-installation body 7. In this state, the holder 5 where the sensor body 3 is installed is installed on the holder-installation body 7 (See FIGS. 2, 4, etc.).

The installation structure 1 of the sensor comprises the sensor body 3, the holder 5 where the locking part 9 is provided, and the holder-installation body 7 where the installable portion 15 is provided. The locking part 9 of the holder 5 is deformed when installing the sensor body 3 and is restored when the installation of the sensor body 3 is completed. And since the sensor body 3 is locked to the locking part 9, the sensor body 3 is installed in the holder 5. Furthermore, since the holder 5 is installed in the installable portion 15 of the holder-installation body 7, the deformation of the knocking part 9 of the holder 5 is prevented.

Thus, the deformation of the locking part 9 of the holder 5 installed in the holder-installation body 7 is prevented, and a joining strength between the sensor body 3 and the holder 5 can be increased without increasing the size of the sensor 13. Moreover, the disengagement of the fitting between the holder 5 and the sensor body 3 can be prevented, and the holding force between the holder-installation body 7, the holder 5 and the sensor body 3 can be improved.

In the installation structure 1 of the sensor, the holder 5 is formed in a U-shape with the bottom section 19 and the pair of side sections 21 standing from the opposite edges of the bottom section 19. Tins configuration makes it easy to eliminate the undercut part when the holder 5 is molded by a mold, and a structure of the mold is simplified by eliminating the undercut part.

In addition, in the installation structure 1 of the sensor, since the locking part 9 of the holder 5 is composed of the pair of side sections 21, the locking part 9 of the holder 5 is easily deformed when the sensor body 3 is installed in the holder 5.

In addition, in the installation structure 1 of the sensor, since the side sections 21 are curved along the arc of the circle centered on the center of the holder 5, when the side sections 21 are considered to be cantilevers protruding from the bottom section 19, the section modulus of the side sections 21 at the time of design can be easily set to an appropriate size.

In the installation structure 1 of the sensor, the protrusions 27 of the lockable part 11 of the sensor body 3 abuts on the holder 5 with the biasing force after the sensor body 3 has been installed on the holder 5. This configuration prevents slight rattling between the sensor body 3 and the holder 5 after the sensor body 3 has been installed on the holder 5.

In the installation structure 1 of the sensor, when the holder 5 has been installed on the installable portion 15, the pair of elastic arms 26 are restored, and the flange 23 abuts on the upper surface in the thickness direction of the flat plate-shaped part 29 of the installable portion 15. In addition, the sensor installation structure 1 is configured so that the holder 5 is installed on the holder-installation body 7 when, for example, a predetermined pair of contact surfaces 35 of the multiple contact surfaces 33, 35 of the pair of elastic arms 26 abuts on the lower surface in the thickness direction of the flat plate-shaped part 29 of the installable portion 15. In some cases, the holder 5 is installed on the holder-installation body 7 when another predetermined pair of contact surfaces 33 of the multiple contact surfaces 33, 35 of the pair of elastic arms 26 abuts on the lower surface in the thickness direction of the flat plate-shaped part 29 of the installable portion 15.

Thus, even when the thickness of the flat part 29 of the holder-installation body 7 changes, the holder 5 can be installed on the flat plate-shaped pan 29 of the holder-installation body 7. In the case of the holder 5 illustrated in FIG. 2, FIG. 7, etc., the thickness of two types of flat plate-shaped part 29 can be accommodated.

In the installation structure 1 of the sensor, the entire holder 5 is formed symmetrically with respect to a plane perpendicular to the lateral direction LA and including the center of the holder 5. The through-hole 31 of the holder-installation body 7 is also formed symmetrically with respect to a plane perpendicular to the lateral direction LA and including the center of the through-hole 31.

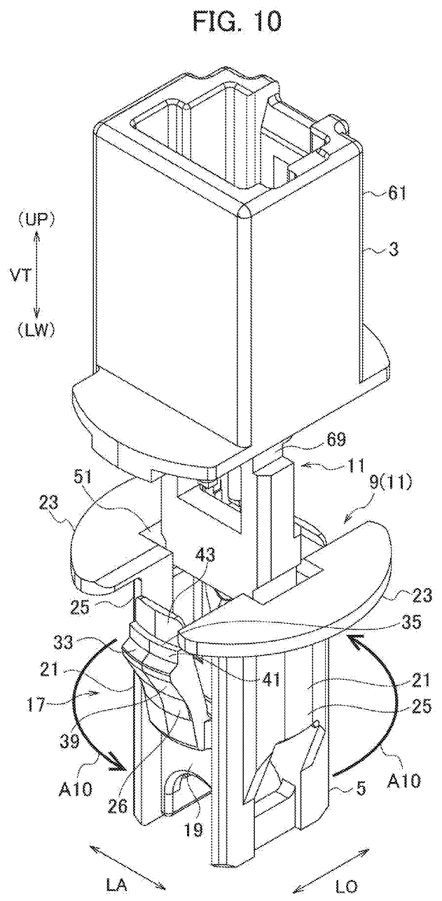

Thus, when the holder 5 is installed in the holder-installation body 7, the holder 5 can be installed in the holder installation body 7 even if the direction of the holder 5 relative to the holder-installation body 7 is rotated by 180 degrees (see arrow A10 in FIG. 10). Even when the through-hole 31 of the holder-installation body 7 is formed in a circular or a rectangular shape, the holder 5 can be installed in the holder-installation body 7 by rotating the direction of the holder 5 relative to the holder-installation body 7 by 180 degrees. When the through-hole 31 of the holder-installation body 7 is formed in a circular shape, the direction of the holder 5 relative to the holder-installation body 7 can be changed by any angle. Thus, when it is necessary to prevent the change of any angle, a detent such as a key may be provided.

In the installation structure 1 of the sensor, the holder-installation body 7 is a duct though which air flows, and the sensor body 3 detects the air temperature (for example, the temperature of the intake air for cooling a high-voltage battery) in the duct 7. Thus, the holder 5 and the sensor body 3 can be rigidly installed in the duct 7, the temperature of the intake air can be accurately detected, and the high-voltage battery can be appropriately cooled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An installation structure of a sensor comprising:
a sensor body;
a holder provided with a locking part and configured to install the sensor body by locking the sensor body with the locking part, the locking part configured to deform when installing the sensor body to the holder and configured to restore when installation of the sensor body to the holder is completed, and
a holder-installation body provided with an installable portion where the holder is to be installed and configured to prevent a deformation of the locking pan of the holder.

2. The installation structure of the sensor according to claim 1, wherein
the holder comprises a bottom section and a pair of side sections standing from opposite edges of the bottom section to form a U-letter shape, and the locking part of the holder is formed by the pair of side sections.

3. The installation structure of the sensor according to claim 2, wherein
when viewed from the standing direction of the pair of side sections, the pair of side sections is curved along an arc of a circle having a center at a center of the holder.

4. The installation structure of the sensor according to claim 2, wherein
the sensor body comprises a lockable part, and
in a state an installation of the sensor body in the holder is completed, the sensor body is installed in the holder by locking the locking part of the holder to the lockable part of the sensor body,
the installation structure of the sensor is configured to take at least one of a first mode, in the first mode, at least a part of the lockable part of the sensor body abuts the holder with a biasing force in the state the installation of the sensor body in the holder is completed, and a second mode, in the second mode, at least a part of the locking part of the holder abuts the sensor body with a biasing force in the state the installation of the sensor body in the holder, is completed.

5. The installation structure of the sensor according to claim 2, wherein
the installable portion of the holder-installation body has a flat plate-shaped part and a though-hole penetrating the flat plate-shaped part,
the holder is provided with an installation portion, the installation portion comprising a flange provided at each tip of the pair of side sections and a pair of elastic arms,
each tip part of the pair of elastic arms comprises a plurality of contact surfaces, and
the installation structure of the sensor is configured such that when the holder is installed in the installable portion while the holder is inserted into the though-hole provided in the flat plate-shaped part of the installable portion, the pair of elastic arms are elastically deformed, the pair of elastic arms are restored when the holder is installed in the installable portion, the flange abut on a first side in a thickness direction of the flat plate-shaped part of the installable portion, and the holder is installed in the holder-installation body by a predetermined pair of contact surfaces, included in the plurality of contact surfaces, of the pair of elastic arms abut on a second side in the thickness direction of the flat plate-shaped pan of the installable portion.

6. The installation structure of the sensor according to claim 1, wherein
the sensor body is configured to detect air temperature, and
the holder-installation body is a duct through which air flows.
